(19) United States
(12) Patent Application Publication
(10) Pub. No.: US 2012/0108195 A1
(43) Pub. Date: May 3, 2012

(54) METHOD FOR MATCHING AN ANTENNA OF A PORTABLE TERMINAL AND APPARATUS FOR SAME

(75) Inventors: Sang Il Choi, Hwaseong-si (KR); Tae Il Kim, Yongin-si (KR)

(73) Assignee: SAMSUNG ELECTRONICS CO., LTD., Suwon-city, Gyeonggi-do (KR)

(21) Appl. No.: 13/381,269

(22) PCT Filed: Jun. 22, 2010
(86) PCT No.: PCT/KR10/04037

§ 371 Date: Dec. 28, 2011

(30) Foreign Application Priority Data
Jul. 2, 2009 (KR) 10-2009-0059995

(51) Int. Cl. H04B 1/10

(52) U.S. Cl. 455/296

(57) ABSTRACT

The present invention relates to an antenna matching method and apparatus of a mobile terminal, and the antenna matching method of the present invention includes configuring a predetermined matching value for an antenna corresponding to a channel selected in broadcast reception mode and adjusting, when reception performance is degraded on the channel, the matching value. According to the present invention, it is possible to support adaptive control for optimizing the frequency matching characteristic according to the variation of the antenna performance using control signal. As a consequence, it is possible to provide the mobile terminal with optimal signal reception environment.

### BACKGROUND OF THE INVENTION

1. Field of the Invention

The present invention relates to an antenna matching method and apparatus of a mobile terminal and, in particular, to a method and apparatus for adjusting the matching characteristic of the antenna automatically according to the variation of the reception performance of the mobile terminal.

2. Description of the Related Art

Typically, a mobile terminal is equipped with an antenna for radio communication. In order to improve the reception performance without impeding design freedom of the mobile terminal, many researches are being conducted. Many models of recently emerging mobile terminals are equipped with an intenna, and there is necessity on the development of antenna for the terminal to receive mobile broadcast (DMB and ISDB-T) on Ultra-High Frequency (UHF) with which intenna implementation is difficult.

Typically, most mobile broadcast services use very broad frequency bandwidth, e.g. 470 MHz to 800 MHz. However, the antenna of the mobile terminal can cover relatively narrow frequency bandwidth. Thus, the antenna of the mobile terminal is configured in tunable structure for covering extended frequency bandwidth in which the matching position is changed according to a control signal of a predetermined format from a modem. The control signal can be Pulse Width Modulation (PWM) signal or logical signal defining by General Purpose Input/Output (GOIP) pin depending on the type of intenna. In case of the intennas under development, control methods and control signal values vary depending on the antenna manufacturer and type of the antenna. Accordingly, the control signals should be modified/applied in match with the antenna of the mobile terminal so as to increase development delay and whole manufacturing costs and, the problem is likely to deteriorate as the broadcast technology application becomes widespread.

Although it is mounted to the mobile terminal under the same condition as an external antenna, the intenna has a risk of reception performance variation. Furthermore, the intenna manufacturing process has a drawback in that it is difficult to take a separate calibration stage for adapting the intenna to various types of mobile terminals due to the cost problem.

### DISCLOSURE OF INVENTION

### Technical Problem

By taking notice of the above problems, it is an object of the prevent invention to provide an antenna matching method and apparatus of a mobile terminal that is capable of adjusting the intenna or antenna matching automatically even when the mobile terminal is in use.

### Solution to Problem

In accordance with an aspect of the present invention, an antenna matching method of a mobile terminal includes configuring a predetermined matching value for an antenna corresponding to a channel selected in broadcast reception mode, and adjusting, when reception performance is degraded on the channel, the matching value. Preferably, adjusting includes checking a performance degradation reason and changing the matching value according to the performance degradation reason.

Preferably, checking includes comparing an error rate of signal received on the channel and a predetermined error rate threshold and comparing a single-to-noise ratio of the signal with a predetermines signal-to-noise ratio threshold. Preferably, changing includes changing the matching value when the error rate of the signal is greater than the error rate threshold and the signal-to-noise ratio of the signal is greater than the signal-to-noise ratio threshold. Preferably, checking includes determining whether the performance degradation reason is current location.

In accordance with another aspect of the present invention, an antenna matching apparatus of a mobile terminal includes an antenna for receiving broadcast signal on a channel selected in broadcast reception mode; a control unit for configuring a predetermined matching value corresponding to the channel and adjusting, when reception performance is degraded on the channel, the matching value; and a matching unit for providing antenna matching in match with the channel according to the matching value under the control of the control unit. Preferably, the control unit checks a performance degradation reason and changes the matching value according to the performance degradation reason.

Preferably, the matching unit includes a plurality of circuits having different impedances and a switch module for connecting one of the circuits to the antenna under the control of the control unit to providing antenna matching.

Preferably, the control unit compares an error rate of signal received on the channel and a predetermined error rate threshold and compares a single-to-noise ratio of the signal with a predetermined signal-to-noise ratio threshold to check the performance degradation reason. Preferably, the control unit changes the matching value when the error rate of the signal is greater than the error rate threshold and the signal-to-noise ratio of the signal is greater than the signal-to-noise ratio threshold. Preferably, the control unit determines whether the performance degradation reason is current location.

### ADVANTAGEOUS EFFECTS

According to the present invention, it is possible to support adaptive control for optimizing the frequency matching characteristic according to the variation of the antenna performance using control signal. As a consequence, it is possible to provide the mobile terminal with optimal signal reception environment.

### BRIEF DESCRIPTION OF THE DRAWINGS

FIG. 1 is a schematic diagram illustrating a configuration of the mobile terminal according to an embodiment of the present invention.

FIG. 2 is a diagram illustrating a matching table according to an embodiment of the present invention.

FIG. 3 is a flowchart illustrating an antenna matching method of the mobile terminal according to an embodiment of the present invention.

FIG. 4 is a graph illustrating effect of the antenna matching method according to an embodiment of the present invention.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed description of well-known functions and structures incorporated herein may be omitted to avoid obscuring the subject matter of the present invention.

Although the descriptions is directed to the mobile terminal supporting digital broadcast, the present invention is not limited thereto. That is, the mobile terminal according to an embodiment of the present invention can be, as well as digital broadcast receiver, any of information communication and multimedia devices and their equivalents including Personal Digital Assistant (PDA), Smart Phone, International Mobile Telecommunication 2000 (IMT-2000) terminal, Wideband Code Division Multiple Access (WCDMA) terminal, and Universal Mobile Telecommunication Service (UMTS) terminal.

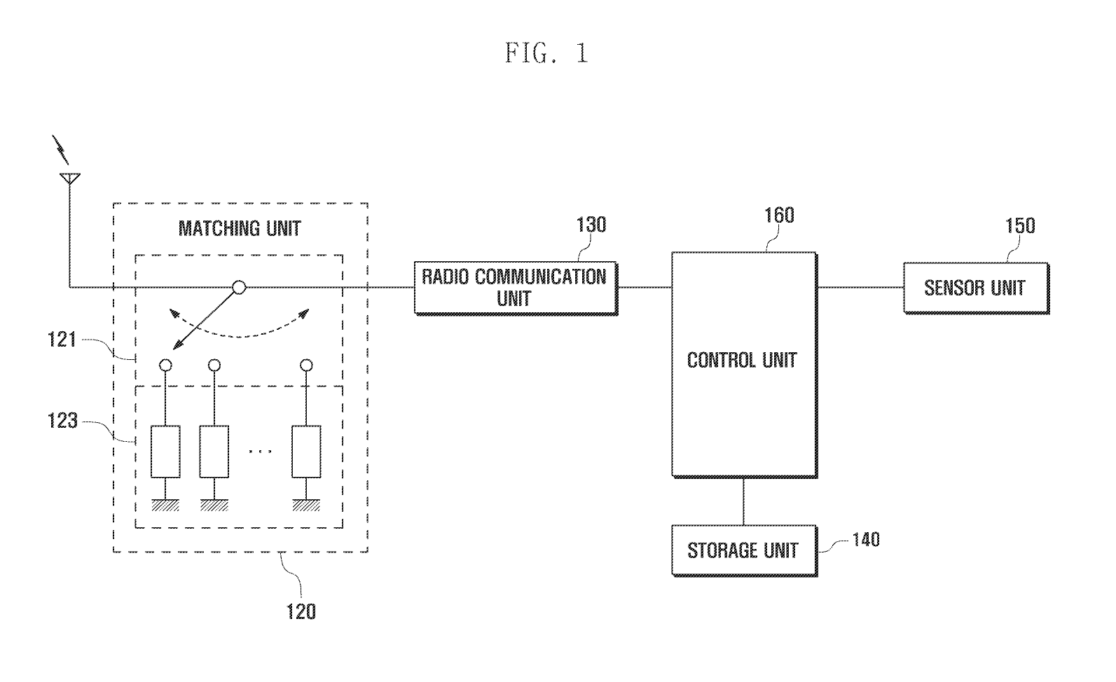

First, a description is made of the configuration of the mobile terminal according to an embodiment of the present invention. FIG. 1 is a schematic diagram illustrating a configuration of the mobile terminal according to an embodiment of the present invention.

Referring to FIG. 1, the mobile terminal according to an embodiment of the present invention includes an antenna unit 110, a matching unit 120, a radio communication unit 130, a storage unit 140, a sensor unit 150, and a control unit.

The antenna unit 110 basically transmits and receives radio frequency signals. That is, the antenna unit 110 receives the radio frequency signals on a specific frequency band selectively and radiates radio signal on the specific frequency band over the air. Here, the antenna unit 110 can be implemented inside of the mobile terminal case in the form of so called “intenna.” The antenna unit 110 also can be implemented as a tunable antenna that is capable of changing the matching characteristic according to the switching in the matching unit 120. The antenna unit 110 also can be implemented as an external antenna.

The matching unit 120 adjusts the matching characteristic of the antenna unit 110 under the control of the control unit 160. For this purpose, the matching unit 120 includes matching circuits 123 having different impedance values and a switch module 121 for adjusting the matching characteristic by switching the antenna unit 110 among the matching circuits 123 under the control of the control unit 160.

The radio communication unit 130 receives radio frequency analog signal, converts the received analog signal to digital signal, and outputs the digital to the control unit 160. The radio communication unit 130 also receives a digital signal from the control unit 160, converts the digital signal to radio frequency analog signal, and outputs the analog signal to the antenna unit 110. The radio communication unit 130 can include a transmitter (Tx) for converting the modulation signal from the control unit 160 to radio frequency signal, amplifying the radio frequency signal, and outputting the amplified signal to the antenna unit 110; and a receiver (Rx) for receiving radio frequency signal, low-noise-amplifying (LNA) the received radio frequency signal, converting the amplified signal to baseband signal, and outputting the baseband signal to the control unit 160. If the mobile terminal is a digital broadcast receiver, the radio communication unit 130 may have no transmitter.

The storage unit 140 stores application programs related to the functions according to an embodiment of the present invention and user data. The storage unit 140 can include a program region and a data region. The program region stores Operating System (OS) for booting the mobile terminal and application programs related to other optional functions. The data region stores the user data generated in the mobile terminal. Particularly, the storage unit 140 stores a matching table according to an embodiment of the present invention. Here, the matching table stores tuning values for respective channels or frequencies, previously tuned values of the respective tuning values, reception performance, usage frequency, and switching reason. The matching table is described later in more detail.

The sensor unit 150 can be a geomagnetic sensor and provides the control unit 160 with the location of the mobile terminal. In case of a bar type mobile terminal, the mobile terminal operates in portrait mode when the short side of the terminal is in parallel with the ground and in landscape mode when the long side of the terminal is in parallel with the ground. The sensor unit 150 determines whether the mobile terminal is in portrait mode or landscape mode, checks the current location of the mobile terminal, and sends the information on the operation mode and current location to the control unit 160.

The control unit 160 generates a control signal to control the matching unit 120 to adjust the matching characteristic of the antenna. If reception performance degradation is detected, the control unit 160 controls to adjust the matching characteristic of the antenna according to the reason of the reception performance degradation to improve the reception performance. At this time, the control unit 160 outputs a control signal for adjusting the matching characteristic by referencing the matching table of the storage unit 140 to control the matching unit 120. The control signal can be a Pulse-Width Modulation (PWM) signal or a logical signal. The control unit 160 performs modulation and coding on the transmission signal and outputs the coded signal to the radio communication unit 130 or performs demodulation and decoding on the received signal and executes an application process corresponding to the signal. For this purpose, the control unit 160 can includes a modem and a codec. In order to execute the application process corresponding to the signal, the mobile terminal may include an application processing device for processing the corresponding application.

Although not depicted, the mobile terminal further includes an audio processing unit having a speaker and a microphone for playing the audio signal output from the control unit 160 and delivering the audio signal including voice input through the microphone to the control unit 160. The mobile terminal further includes an input unit which has a plurality of alphanumeric and function keys for executing and configuring various functions and generates a key signal corresponding to the numeric and alphabetic character input to the control unit 160. The mobile terminal can further include a Universal Subscriber Identity Module (USIM). The USIM stores a service identifier for use in authentication to a base station for radio communication based on a specific protocol and in ciphering and deciphering for tunneling. The USIM can be implemented as a detachable module. Although not enumerated due to diverse modifications, it is obvious to those skilled in the art that the mobile terminal can further include various units equivalent to the aforementioned units according to the digital device convergence tendency.

The mobile terminal according to an embodiment of the present invention stores informations on the optimal matching characteristics for the environment varying according to its operation and compensates the matching characteristic of the antenna based on these informations in real time. As aforementioned, the matching characteristics are stored in the matching table, and the mobile terminal can adjust the characteristic of the antenna using matching table. The matching table is described later in detail.

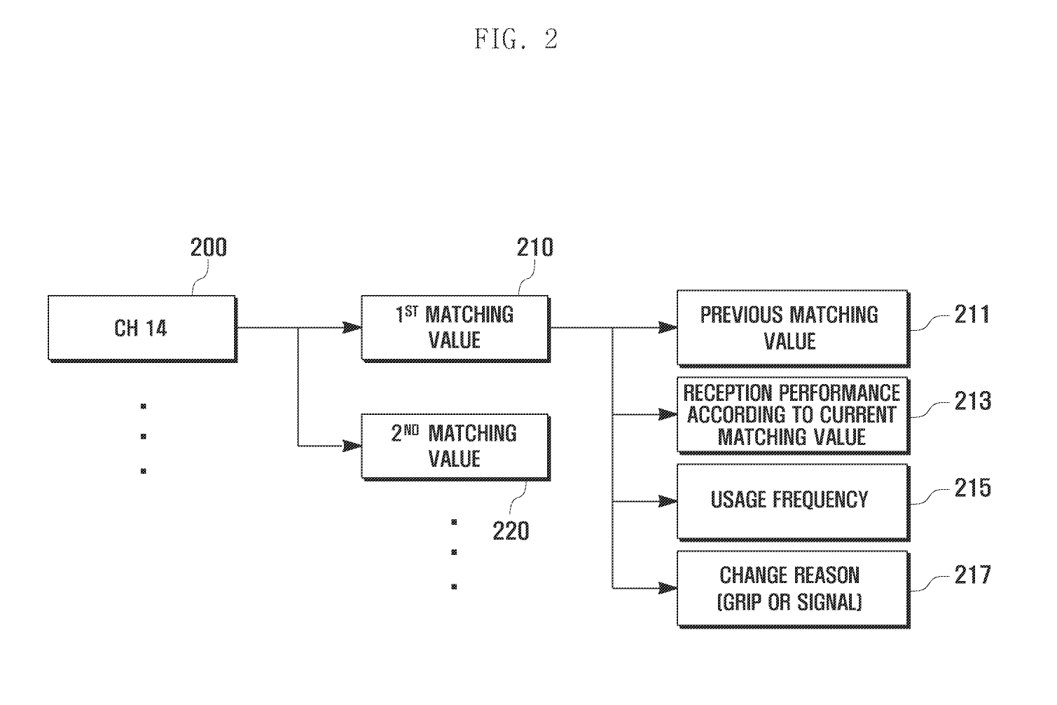

FIG. 2 is a diagram illustrating a matching table according to an embodiment of the present invention.

Referring to FIG. 2, the matching table according to an embodiment of the present invention includes a plurality of matching values 210, 220, . . . per frequency band or channel 200 on which digital broadcast signal is received. The matching values corresponding to the frequency band or channel 200 are determined based on a number of matching circuits of the matching unit 120 and the values determined by the matching circuits. That is, the individual matching values correspond to the respective matching circuits and represent impedances determined by the corresponding matching circuit. Here, the matching value 210 corresponding to the frequency band or channel 200 stores the previous matching values 211, reception performance 213, usage frequency 215, and change reason. Corresponding to each frequency band or channel 200, the matching values can be arranged in order of priority determined at least one of the matching value 211, reception performance 213, usage frequency 215, and change reason.

The previous matching value 211 means the matching value before applying the corresponding matching value 210.

The reception performance 213 means the reception performance improved by updating the matching value 210. The reception performance 213 can be determined based on variation amount of the error rate of the signal according to the update from the previous matching value 211 to the current matching value 210, i.e. Bit Error Rate (BER) or Packet Error Rate (PER). Also, the reception performance 213 can be determined based on the Signal-to-Noise Ratio (SNR).

The usage frequency 215 means the frequency of the use of the corresponding matching value 211 and has an accumulated value.

The change reason means the reason of the change from the previous matching value 211 to the corresponding matching value 210. The change reason 217 includes the change of the terminal location and the change of a characteristic parameter value. Here, the parameter can include SNR, BER, and PER.

If the reception performance is degraded according to the state of the received signal, the mobile terminal according to an embodiment of the present invention controls the matching characteristic of the antenna according to the reason. In an embodiment of the present invention, the reception performance degradation according to the received signal state can be categorized into three categories: case where simply the reception signal is weakened, case where the signal is changed according to the location of the mobile terminal, and case where a specific parameter value is changed.

With the exception of the case where simply the received signal strength is weakened, the matching characteristic of the antenna is changed to a specific matching value. After measuring the reception performance with the changed matching characteristic of the antenna, if the reception performance is improved, the mobile terminal stores the reason of the reception performance degradation as change reason 217 and stores the matching value 210 improving the reception performance in that state in the matching table. If the matching value 210 is accumulated over a predetermined number of times and if the reception performance degradation takes place by the change reason 217, the mobile terminal can change the matching characteristic for the corresponding matching value 210.

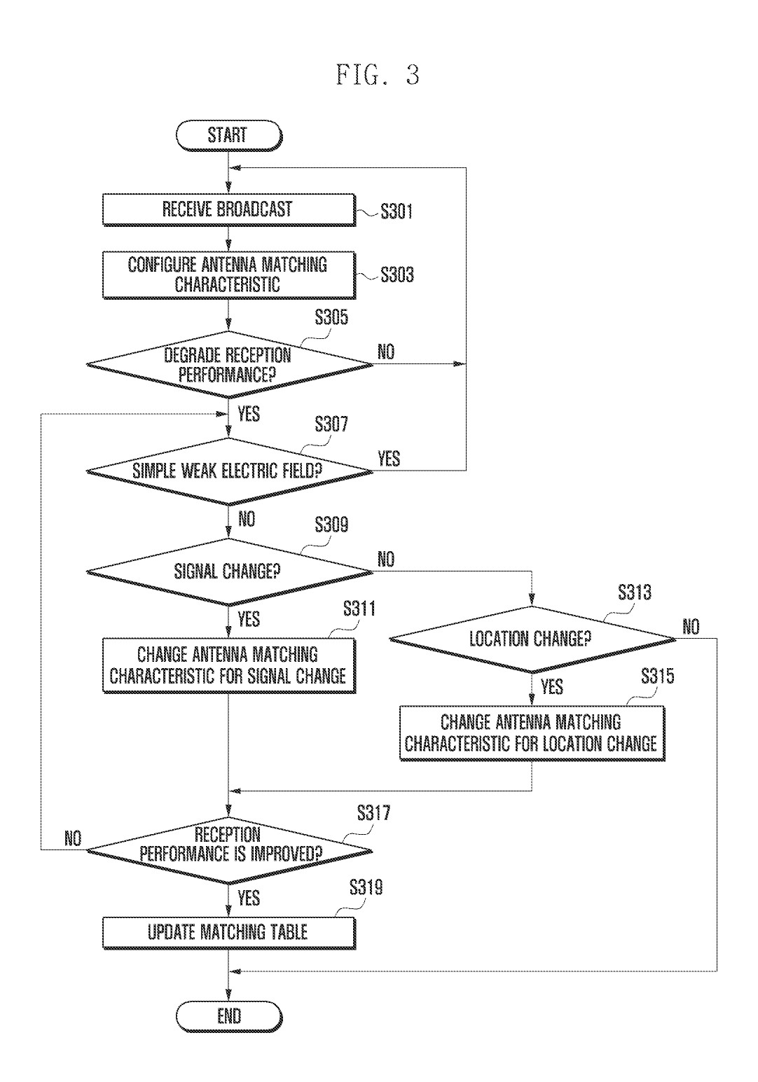

A description is made of the matching method of the mobile terminal according to an embodiment of the present invention. FIG. 3 is a flowchart illustrating an antenna matching method of the mobile terminal according to an embodiment of the present invention. In FIG. 3, it is assumed that the mobile terminal is a digital broadcast receiver.

Referring to FIG. 3, in the matching procedure of the antenna unit 110 according to this embodiment, the control unit 160 first receives the broadcast at step S301. At this time, the control unit 160 selects a channel 200 for receiving the broadcast. Next, the control unit 160 looks up the matching table to configure the matching characteristic of the antenna unit 110 at step S303. At this time, the control unit 160 checks the priorities of the matching values 210 per the channel 200 to select the matching value having the highest priority. Next, the control unit 160 selects a matching circuit corresponding to the matching value 210 among the matching circuits 123 and connects the selected matching circuit to the antenna unit 110 by means of the switching module 121.

Next, the control unit 160 determines whether the reception performance degradation takes place on the corresponding channel 20 at step S305. If it is determined no reception performance degradation takes place, the control unit 160 returns the procedure to step S301 to maintain receiving broadcast. If it is determined that reception performance degradation takes place at step S305, the control unit 160 determines whether the reason of the reception performance degradation is weak electric field environment at step S307. At this time, the control unit 160 can compare SNR of the received signal with a predetermined SNR threshold. The control unit 160 can determine whether the current SNR is greater than the SNR threshold. If the current SNR is equal to or less than the SNR threshold, the control unit 160 determines that the current signal reception environment is weak electric field environment, and returns the procedure to step S301 to continue receiving the broadcast.

If it is determined that the reason of the reception performance degradation is not the weak electric field environment at step 307, the control unit 160 determines whether the reason of the reception performance degradation is signal variation at step S309. At this time, the control unit 160 can compare the received signal error rate, i.e. bit error rate or packet error rate, with a predetermined error rate threshold. The control unit 160 also can determine whether the received signal error rate is greater than the error rate threshold.

If it is determine that the reason of the reception performance degradation is the signal variation at step S309, the control unit 160 adjusts the matching characteristic of the antenna unit 110 at step S311. That is, if the SNR of the received signal is greater than SNR threshold or if the error rate of the received signal is greater than the error rate threshold, the control unit 160 determines that the reason of the reception performance degradation is the signal variation. At this time, if the reason of the reception performance degradation is the signal variation, the control unit 160 selects the corresponding previous matching value 211. Next, the control unit 160 selects the matching circuit corresponding to the matching value 210 among the matching circuits 123 and connects the selected matching circuit to the antenna unit 110 via the switch module 121.

If it is determined that the reason of the reception performance degradation is not signal variation at step 309, the control unit 160 determines whether the reason of the reception performance degradation is location change of the mobile terminal at step S313. That is, if the reception performance takes place, if the SNR of the received signal is greater than SNR threshold, and if the error rate of the received signal is equal to or less than the error rate threshold, the control unit 160 can determine that the reason of the reception performance degradation is the location change of the mobile terminal. Here, the control unit 160 can checks the location of the mobile terminal by means of the sensor unit 150. If it is determined that the reason of the reception performance degradation is the location change of the mobile terminal, the control unit 160 adjusts the matching characteristic of the antenna unit 110 at step S315. At this time, the control unit 160 looks up the matching table to select the previous matching value 211 corresponding to the matching value 210. Next, the control unit 160 selects another matching circuit corresponding to the matching value 210 among the matching circuits 123 and connects the selected matching circuit to the antenna unit 110 via the switch module 121.

Finally, the control unit 160 determines whether the reception performance is improved on the corresponding channel 200 at step S317. If the reception performance is not improved in spite of applying the matching value 210, the control unit 160 returns the procedure to step S307 and repeats steps S307 to S317. That is, the control unit 160 checks the reason of the reception performance degradation and changes the matching characteristic of the antenna unit 110 according to the reason of the reception performance degradation. The control unit 160 selects another matching circuit corresponding to the matching value 210 among the matching circuits 123 and connects the selected matching circuit to the antenna unit 110 via the switch module 131. If it is determined that the reception performance is improved at step S317, the control unit 160 updates the matching table at step S319. At this time, the control unit 160 changes the corresponding matching value 210 for the previous matching value 211 in match with the current change reason 217, reflects the reception performance change according to the change of the previous matching value 211 for the corresponding matching value 210 to the reception performance 213 according to the corresponding matching value 210, and increases the usage frequency of the corresponding matching value 210. The control unit 160 also can change the priorities of the matching values 210 in the matching table according to the change of at least one of previous matching value 211 corresponding to the matching value 210, reception performance 213, usage frequency 215, and change reason 217.

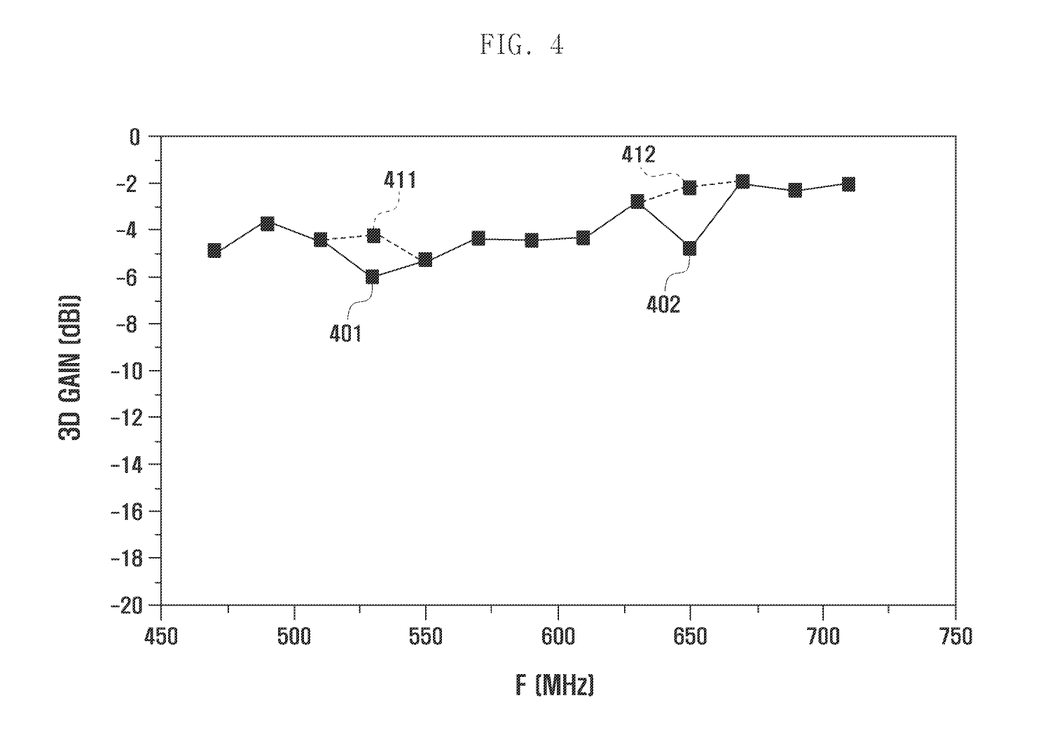

A description is made of the effect of the antenna matching method according to an embodiment of the present invention. FIG. 4 is a graph illustrating effect of the antenna matching method according to an embodiment of the present invention.

Referring to FIG. 4, the mobile terminal may undergo reception performance degradation at a specific frequency band (F) as indicated by reference numbers 401 and 402. This may take place due to the SNR/BER degradation in decoding the received signal. It is possible to optimize the antenna matching characteristic by changing control signal instantly. Particularly in case of using the antenna matching method according to an embodiment of the present invention, the antenna matching value can recover the antenna matching value for optimal performance immediately after the antenna performance degradation occurs as indicated by reference numbers 411 and 412. That is, the mobile terminal can maintain the peak gain value within a predetermined range on the corresponding frequency band.

Although the description is directed to the case where, if the reception performance is degraded on a specific channel, the mobile terminal changes the current matching value for the previous matching value, the present invention is not limited thereto. The mobile terminal can selects one of the matching values in the matching table and change the current matching value for the selected matching value.

According to the present invention, it is possible to support adaptive control for optimizing the frequency matching characteristic according to the variation of the antenna performance using control signal.

Although the description has been made with reference to particular embodiments, the present invention can be implemented with various modification without departing from the scope of the present invention. Thus, the present invention is not limited to the particular embodiments disclosed but will include the following claims and their equivalents.

What is claimed is:

1. An antenna matching method of a mobile terminal, comprising:
configuring a predetermined matching value for an antenna corresponding to a channel selected in broadcast reception mode; and
adjusting, when reception performance is degraded on the channel, the matching value.

2. The antenna matching method of claim 1, wherein adjusting comprises:
checking a performance degradation reason; and
changing the matching value according to the performance degradation reason.

3. The antenna matching method of claim 2, wherein checking comprises:
comparing an error rate of signal received on the channel and a predetermined error rate threshold; and
comparing a single-to-noise ratio of the signal with a predetermines signal-to-noise ratio threshold.

4. The antenna matching method of claim 3, wherein changing comprises changing the matching value when the error rate of the signal is greater than the error rate threshold and the signal-to-noise ratio of the signal is greater than the signal-to-noise ratio threshold.

5. The antenna matching method of claim 2, wherein checking comprises determining whether the performance degradation reason is current location.

6. The antenna matching method of claim 1, further comprising determining, when reception performance is improved, current matching value to be configured according to the selection of the channel.

7. The antenna matching method of claim 1, wherein the matching value is impedance.

8. An antenna matching apparatus of a mobile terminal, comprising:
an antenna for receiving broadcast signal on a channel selected in broadcast reception mode;
a control unit for configuring a predetermined matching value corresponding to the channel and adjusting, when reception performance is degraded on the channel, the matching value; and
a matching unit for providing antenna matching in match with the channel according to the matching value under the control of the control unit.

9. The antenna matching apparatus of claim 8, wherein the matching unit comprises:
a plurality of circuits having different impedances; and
a switch module for connecting one of the circuits to the antenna under the control of the control unit to providing antenna matching.

10. The antenna matching apparatus of claim 8, wherein the control unit checks a performance degradation reason and changes the matching value according to the performance degradation reason.

11. The antenna matching apparatus of claim 10, wherein the control unit compares an error rate of signal received on the channel and a predetermined error rate threshold and compares a single-to-noise ratio of the signal with a predetermined signal-to-noise ratio threshold to check the performance degradation reason.

12. The antenna matching apparatus of claim 11, wherein the control unit changes the matching value when the error rate of the signal is greater than the error rate threshold and the signal-to-noise ratio of the signal is greater than the signal-to-noise ratio threshold.

13. The antenna matching apparatus of claim 10, wherein the control unit determines whether the performance degradation reason is current location.

14. The antenna matching apparatus of claim 8, wherein the control unit determines, when reception performance is improved, current matching value to be configured according to the selection of the channel.
